(19) United States
(12) Patent Application Publication
(10) Pub. No.: US 2017/0017339 A1
(43) Pub. Date: Jan. 19, 2017

(54) TOUCH-CONTROLLED ELECTRONIC DEVICE AND OPERATING METHOD THEREOF

(71) Applicant: Intel Corporation, Santa Clara, CA (US)

(72) Inventors: Jinfeng Zhou, Hangzhou (CN); Zhichong Chen, Hangzhou (CN)

(21) Appl. No.: 15/185,501

(22) Filed: Jun. 17, 2016

(30) Foreign Application Priority Data
Jul. 17, 2015 (CN) 201510424755.9

(51) Int. Cl. G06F 3/041; G06F 1/16

(52) U.S. Cl. CPC G06F 3/0416; G06F 3/0412; G06F 1/1613

(57) ABSTRACT

The present invention discloses a flat panel device and a method for operating a flat panel device. The flat panel device has a reset switch. The reset switch is used to disconnect a battery of the flat panel device from a load so as to force to turn off the flat panel device when a touch control panel of the flat panel device is disabled.

### TECHNICAL FIELD

The present invention relates to a crash processing technology for a flat panel device.

### BACKGROUND

A flat panel device comprises a device using a touch control panel as an input interface, such as a smart phone and a tablet.

However, when the flat panel device crashes, the touch control panel is also disabled. Taking a smart phone with an embedded battery as an example, the smart phone cannot jump out of a crashed state until the power is exhausted.

### SUMMARY

The present invention aims to provide a flat panel device and a method for operating a flat panel device so as to solve the above-mentioned problem.

A flat panel device implemented according to one embodiment of the present invention comprises a touch control panel, a battery and a reset switch. The reset switch is used to disconnect the battery from a load of the flat panel device so as to force to turn off the flat panel device when the touch control panel is disabled.

In one embodiment, the flat panel device restarts along with re-connection of the disconnected reset switch.

In another embodiment, the flat panel device further comprises a power source key. After the re-connection of the disconnected reset switch, the flat panel device restarts along with a press applied to the power source key.

A method for operating a flat panel device implemented according to one embodiment of the present invention comprises: disposing a reset switch on a flat panel device to control a conducting condition of a battery of the flat panel device and a load of the flat panel device; and switching the reset switch to disconnect the battery from the load of the flat panel device, so as to force to turn off the flat panel device when a touch control panel of the flat panel device is disabled.

After switching the reset switch to disconnect the battery from the load of the flat panel device, the method for operating a flat panel device comprises re-switching the reset switch to connect the battery to the load of the flat panel device.

In one embodiment, the flat panel device restarts along with the re-connection of the disconnected reset switch.

In another embodiment, after the re-connection of the disconnected reset switch, the flat panel device restarts along with a press applied to a power source key of the flat panel device.

Contents of the present invention are described in detail with the following specific embodiments in conjunction with accompanying drawings.

### BRIEF DESCRIPTION OF THE DRAWINGS

FIG. 1 is one embodiment of the present invention illustrating a flat panel device 100;

FIG. 2 is one embodiment of the present invention illustrating a reset method for a flat panel device in a flowchart;

FIG. 3A is a schematic diagram of a flat panel device 100_1 implemented by one embodiment of the present invention;

FIG. 3B is a schematic diagram of a flat panel device 100_2 implemented by one embodiment of the present invention; and

FIG. 3C is a schematic diagram of a flat panel device 100_3 implemented by one embodiment of the present invention.

### DETAILED DESCRIPTION OF THE INVENTION

A plurality of embodiments of the present invention are described hereinafter. The following description introduces basic concepts of the present invention, and is not intended to limit the contents of the present invention. The actual scope of the invention should be defined according to the claims.

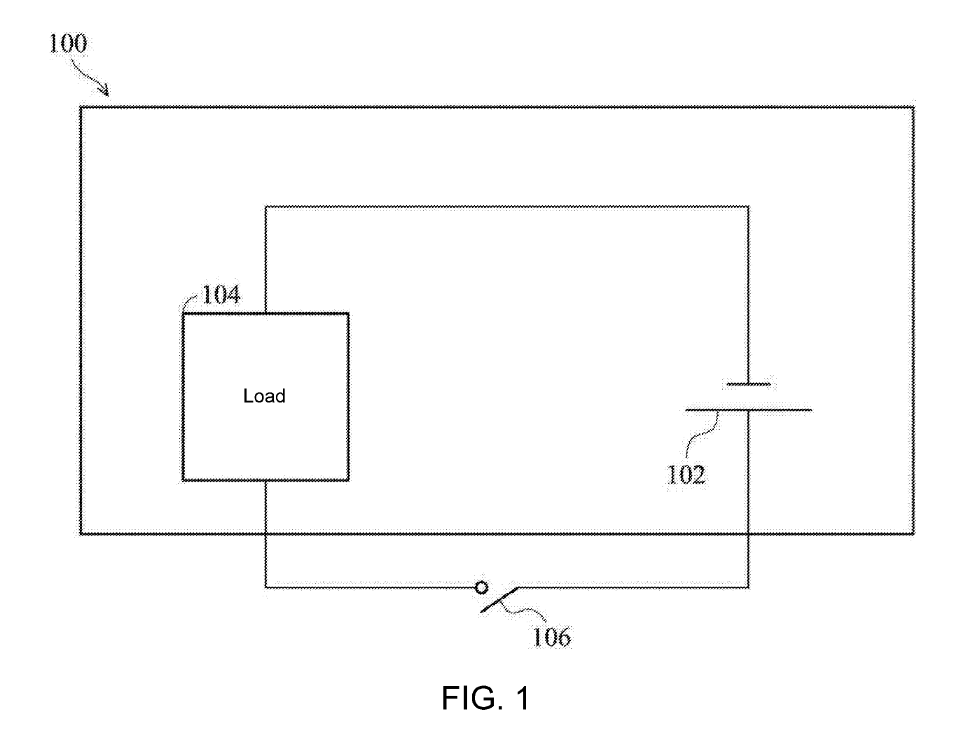

FIG. 1 illustrates a flat panel device 100 according to one embodiment of the present invention.

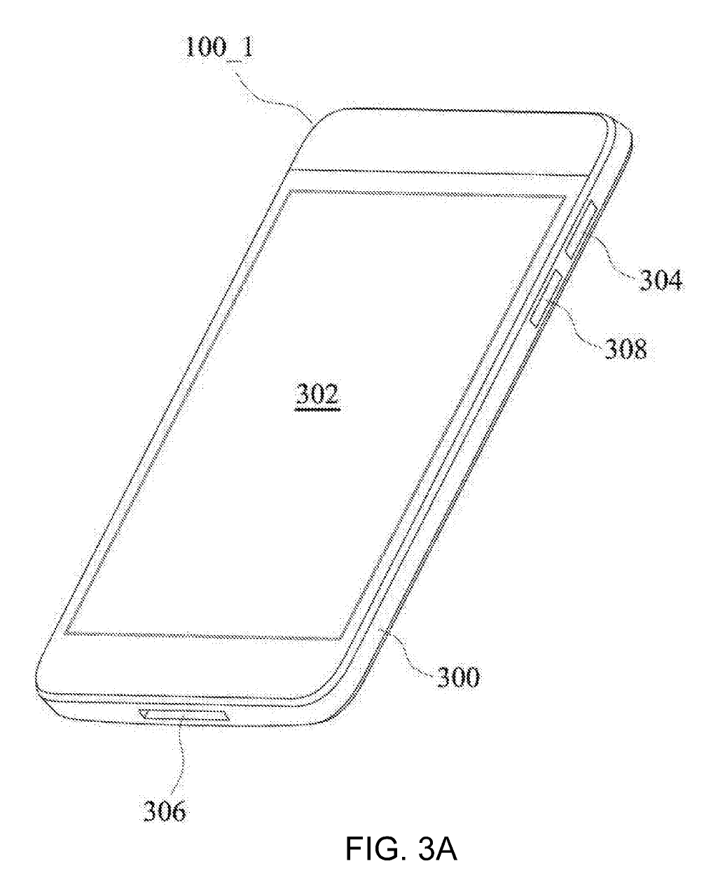

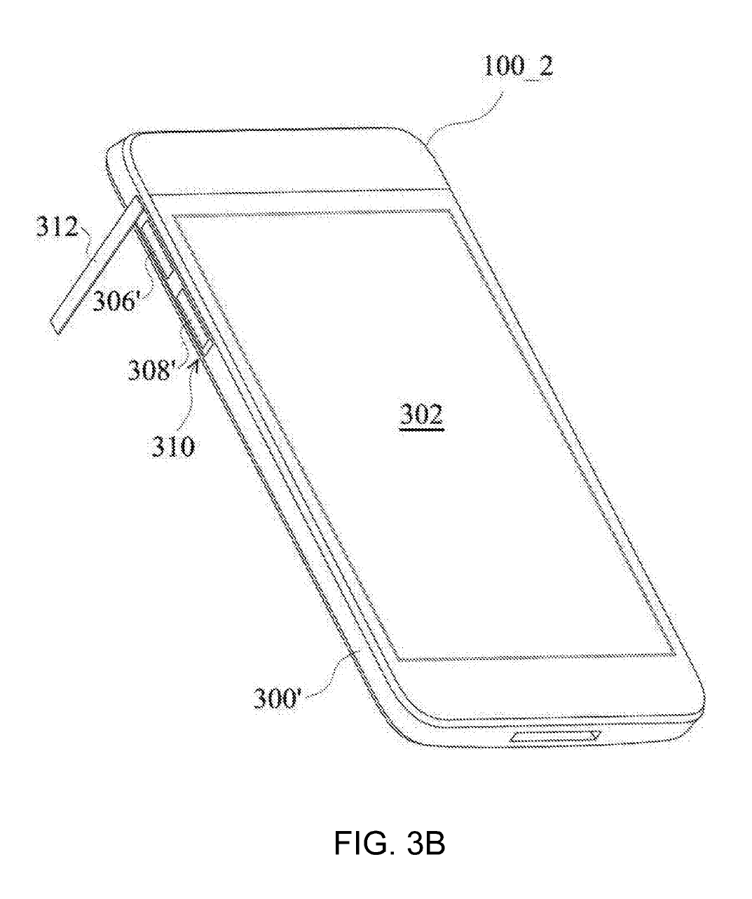

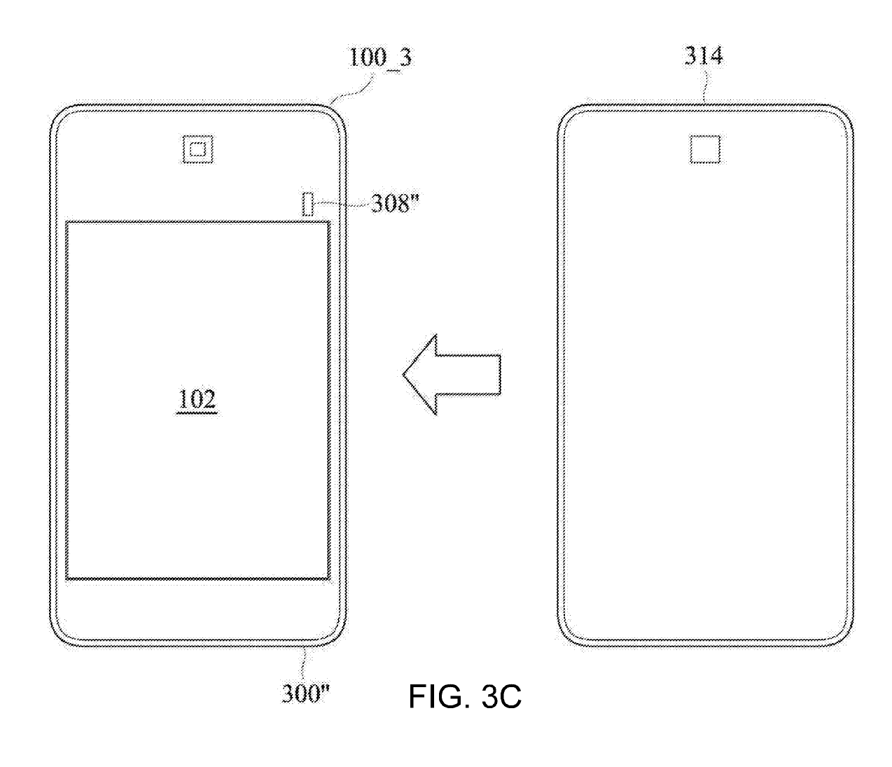

As illustrated in the subsequent FIGS. 3A and 3B, the flat panel device disclosed in the present invention, which may be a smart phone as shown in FIGS. 3A and 3B and also various electronic devices with a touch control panel as an input interface such as a tablet, comprises a touch control panel.

In FIG. 1, in addition to a battery 102, elements on the flat panel device 100 powered by the battery 102 comprising a touch control panel 302 are denoted as a load 104. The flat panel device 100 comprises a reset switch 106 which controls the conducting condition of the battery 102 and the load 104. When the touch control panel of the flat panel device 100 is disabled, for example, when a blank screen occurs, or when the touch control panel does not react due to a system crash, a user may force to turn off the flat panel device 100 by switching the reset switch 106 to disconnect the battery 102 from the load 104. As such, the flat panel device 100 would not be trapped in the crashed condition.

In particular, the reset switch 106 is not prone to be disabled due to system crashes as compared with the techniques of forcing the flat panel device to be turned off by simultaneously pressing a plurality of keys on the flat panel device, such as simultaneously pressing volume up/down keys and the power source key. The user may cause the flat panel device 100 to jump out of a crashed state by toggling the reset switch 106.

In some embodiments, the battery 102 is designed such that it is unable to be removed from the flat panel device 100. The disconnection state of the reset switch 106 namely simulates the effect of removing the battery 102 to force the flat panel device 100 to be turned off so as to avoid the flat panel device 100 being trapped in the crashed state.

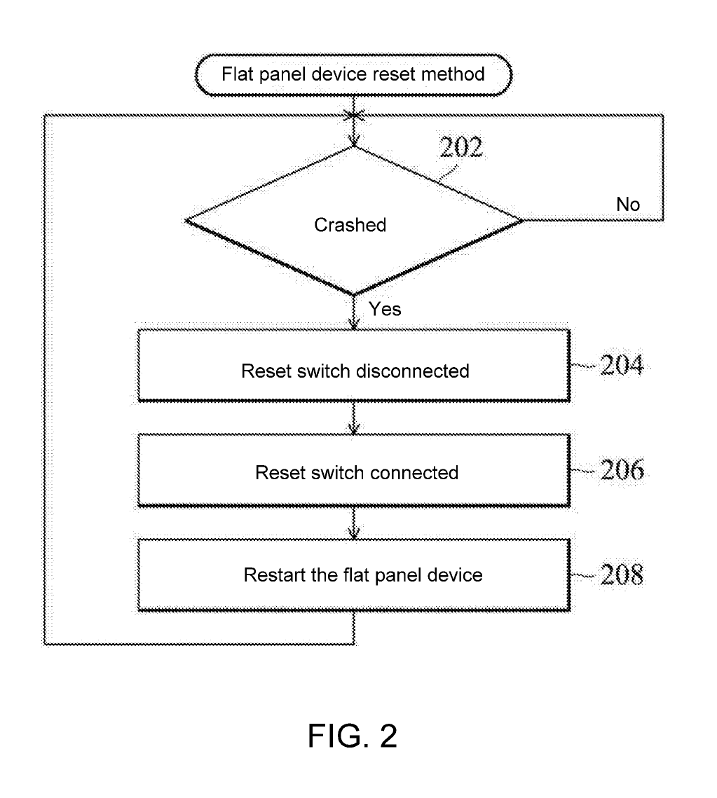

FIG. 2 illustrates a reset method for a flat panel device in a flowchart according to an embodiment of the present invention.

Step 202 determines whether the flat panel device 100 crashes, for example, whether a blank screen occurs in a touch control device 302, or whether the touch control device 302 does not respond to the user's touch control due to a system crash.

If the flat panel device 100 crashes, a user may take step 204, wherein the reset switch 106 is switched, such that the battery 102 is disconnected from the load 104, thereby simulating removing the battery 102 from the flat panel device 100. The flat panel device 100 is thus forced to be turned off and escape the crashed state.

After performing step 204 of switching the reset switch 106 to disconnect the battery 102 from the load 104, the user may take step 206, in which the reset switch 106 is in a disconnected state is switched again so as to connect the battery 102 to the load 104, and then the flat panel device 100 restarts as described in step 208. The user repeatedly performs step 202 to monitor whether the flat panel device 100 crashes.

With regard to the restart of the flat panel device 100 (step 208), one embodiment causes the flat panel device 100 to automatically restart along with the re-connection of the disconnected reset switch 106 without any other action of the user.

In another embodiment, the flat panel device 100 may further comprise a power source key, for example, a power source key labelled as 304 in FIG. 3A. After the disconnected reset switch 106 is re-switched to be connected, the flat panel device 100 restarts along with the press applied to the power source key 304. The user needs to perform the press action on the power source key 304 again.

The reset switch 106 has a plurality of feasible setting positions in terms of mechanism.

FIG. 3A illustrates a flat panel device 100_1 implemented according to one embodiment of the present invention. In addition to framing the touch control panel 302, the enclosure 300 also provides a plurality of openings to correspond to the power source key 304, the transmission line interface 306 and the reset switch 308 (i.e. 106).

Such an explicit design of reset switch 308 is very convenient for the user to toggle. Once the flat panel device 100_1 crashes, the user toggles the explicit reset switch 308 to cause the flat panel device 100_1 to jump out of the crashed state.

In one embodiment, the user may firstly switch the reset switch 308 to be disconnected so as to force the flat panel device 100_1 to be turned off, and then switch the reset switch 308 to be connected. The switch of the reset switch 308 being connected would generate a trigger signal to drive the flat panel device 100_1 to restart spontaneously.

In another embodiment, the user may firstly switch the reset switch 308 to be disconnected so as to force the flat panel device 100_1 to be turned off, and then switch the reset switch 308 to be connected so as to rebuild the conducting relation between the battery of the flat panel device 100_1 and the load. After switching the reset switch 308 to be connected, the user may further press the power source key 304 to cause the flat panel device 100_1 to restart along with the pressing operation by the user on the power source key 304.

FIG. 3A is intended to limit the position of an enclosure opening for the reset switch 308. For example, other embodiments may design the enclosure opening for the reset switch to be at the side where the transmission line interface 306 is located in the figure, or to be at any place on the enclosure convenient for an opening. In addition to connecting transmission lines, the transmission line interface 306 is further used to connect the power source to charge the battery inside the flat panel device 100_1.

The enclosure opening corresponding to the reset switch 308 may further have a waterproof material covered thereon.

FIG. 3B illustrates a flat panel device 100_2 implemented according to one embodiment of the present invention. In addition to framing the touch control panel 302, the enclosure 300′ also provides an opening corresponding to the transmission line interface 306′ and another opening corresponding to the reset switch 308′ (i.e. 106). In addition to connecting transmission lines, the transmission line interface 306′ is also used to connect the power source to charge the battery inside the flat panel device 100_2.

In particular, the enclosure 300′ comprises a groove structure 310. The opening corresponding to the transmission line interface 306′ and the opening corresponding to the reset switch 308′ are opened at the groove structure 310.

In addition, the flat panel device 100_2 comprises a groove outer cap 312 movably covers the groove structure 310 so as to shield the transmission line interface 306′ and the reset switch 308′.

With reference to the design of the flat panel device 100_2, once a crash occurs, the user may push aside the groove outer cover 312 to toggle the reset switch 308′, so as to cause the flat panel device 100_2 to jump out of the crashed state. After the reset switch 308′ to be disconnected is re-switched to a connected state, the user may close the groove outer cap 312.

FIG. 3B is not intended to limit the position of the groove structure 310 on the enclosure 300′. The groove structure 310 may also be adjusted to other spaces of the enclosure 300′.

In other embodiments, the groove structure 310 may also be opened only for the reset switch 308′.

In other embodiments, those opened on the groove structure 310 together with the reset switch 308′ may be other connection interfaces, such as a sound source line interface, or a key.

FIG. 3C illustrates a flat panel device 100_3 implemented according to an embodiment of the present invention. In addition to the enclosure 300″, the flat panel device 100_3 further comprises a battery outer cap 314. The battery outer cover 314 is used to be assembled to the enclosure 300″, so as to cover the battery 102 and the reset switch 308″ (i.e. 106) disposed within the enclosure 300″.

With reference to the design of the flat panel device 100_3, once a crash occurs, the user may remove the battery outer cap 314 and toggle the reset switch 308″, so as to cause the flat panel device 100_3 to jump out of the crashed state. After the reset switch 308″ to be disconnected is re-switched to a connected state, the user may again assemble together the battery outer cap 314 and the enclosure 300″.

FIG. 3C is not intended to limit the position of such an in-built type reset switch 308″. Positions facilitating to control a connection condition between a positive terminal of the battery 102 and the load of the flat panel device 100_3 may all be used to dispose the reset switch.

The reset switch 106 disclosed in the present invention may have various forms. Any switch element capable of switching between “disconnected” and “connected” states can be used to implement the reset switch 106.

Although the present invention is disclosed in conjunction with the above preferred embodiments, it is not intended to limit the present invention. Any person skilled in the art can make some modification and variation without departing from the spirit and scope of the present invention, and thus the scope of protection of the present invention should be subject to that as defined by the appended claims.

1. A flat panel device, comprising:
a touch control panel;
a battery; and
a reset switch for disconnecting the battery from a load of the flat panel device so as to force to turn off the flat panel device when the touch control panel is disabled.

2. The flat panel device of claim 1, further comprising:
an enclosure providing a first opening corresponding to the reset switch for a user to toggle the reset switch.

3. The flat panel device of claim 2, further comprising:
a groove structure, and
wherein the first opening is opened at the groove structure.

4. The flat panel device of claim 3, further comprising:
a groove outer cap movably covering the groove structure.

5. The flat panel device of claim 3, further comprising:
a transmission line interface to be connected to a power source to charge the battery,
wherein
the enclosure further provides a second opening corresponding to the transmission line interface; and
the second opening is opened at the groove structure.

6. The flat panel device of claim 5, further comprising:
a groove outer cap movably covering the groove structure.

7. The flat panel device of claim 1, further comprising:
an enclosure; and
a battery outer cap assembled to the enclosure to cover the battery and the reset switch disposed within the enclosure.

8. The flat panel device of claim 1, the flat panel device restarting along with re-connection of the disconnected reset switch.

9. The flat panel device of claim 1, further comprising:
a power source key,
wherein after the re-connection of the disconnected reset switch, the flat panel device restarts along with a press applied to the power source key.

10. A method for operating a flat panel device, comprising:
disposing a reset switch on a flat panel device to control a conducting condition of a battery of the flat panel device and a load of the flat panel device; and
switching the reset switch to disconnect the battery from the load of the flat panel device so as to force to turn off the flat panel device when a touch control panel of the flat panel device is disabled.

11. The method for operating a flat panel device of claim 10, further comprising:
after switching the reset switch to disconnect the battery from the load of the flat panel device, re-switching the reset switch to connect the battery to the load of the flat panel device,
wherein the flat panel device restarts along with the re-connection of the disconnected reset switch.

12. The method for operating a flat panel device of claim 10, further comprising:
after switching the reset switch to disconnect the battery from the load of the flat panel device, re-switching the reset switch to connect the battery to the load of the flat panel device,
wherein after the re-connection of the disconnected reset switch, the flat panel device restarts along with a press applied to a power source key of the flat panel device.
